(19) United States
(12) Patent Application Publication
(10) Pub. No.: US 2009/0290773 A1
(43) Pub. Date: Nov. 26, 2009

(54) Apparatus and Method to Facilitate User-Modified Rendering of an Object Image

(75) Inventors: Kevin Holt, Chicago, IL (US); Daniel A. Markham, Hoffman Estates, IL (US)

Correspondence Address: FITCH EVEN TABIN AND FLANNERY;VARIAN MEDICAL SYSTEMS, 120 SOUTH LASALLE STREET, SUITE 1600, CHICAGO, IL, 60603-3406, US

(73) Assignee: VARIAN MEDICAL SYSTEMS, INC., Palo Alto, CA (US)

(21) Appl. No.: 12/124,255

(22) Filed: May 21, 2008

(51) Int. Cl. G06K 9/00

(52) U.S. Cl. 382/131

(57) ABSTRACT

A user interface (102) is configurable to provide a user (such as an individual) with a plurality of user-manipulable image reconstruction parameters. A memory (101) has penetrating energy-based image information regarding an object to be rendered stored therein. A viewer (103) (operably coupled to the user interface) is then configurable to render visible an image of this object as a function, at least in part, of this plurality of image reconstruction parameters and a reconstructor (104) (operably coupled to the user interface, the memory, and the viewer) is configurable to respond, substantially in real time, to user manipulation of a given one of the user-manipulable image reconstruction parameters by facilitating automatic near-time rendering of the image of the object as a function, at least in part, of the plurality of image reconstruction parameters including a given one of the user-manipulable image reconstruction parameters.

### TECHNICAL FIELD

This invention relates generally to the visual rendering of object images using penetrating energy-based image information and more particularly to the modification of such images in response to user input.

### BACKGROUND

The use of penetrating energy to gather information regarding an object and the use of such information to render a corresponding image is known in the art. Examples of penetrating energy platforms used for such purposes include, but are not limited to, high energy-based platforms such as x-ray equipment (including computed tomography), magnetic resonance imaging (MRI) equipment, and so forth as well as lower energy-based platforms where appropriate (such as ultrasonic equipment).

The resultant images serve in a wide variety of application settings and for various end purposes. In some cases, the end use and the object to be imaged are predictable and well understood by the manufacturer and the imaging equipment can be carefully designed and calibrated to yield images that are useful to the end user. In other cases, however, the end use and/or the objects to be imaged are less initially well defined. In such a case, it can become necessary to provide the user with greater flexibility regarding one or more data gathering and/or rendering parameters in order to assure that the end user can likely obtain an image satisfactory to their purposes.

Unfortunately, such flexibility has typically come with corresponding burdens. Such capabilities are either very costly (with cost being driven, at least in part, by expensive highly customized hardware rendering platforms (using, for example, field programmable gate arrays) typically costing $10,000 or more, significant development or maintenance costs (including years it can take to properly design a field programmable gate array-based reconstructor), poor accuracy (which is often attributable to the integer-based rather than floating point-based architecture of the implementing platform or the use of approximated floating point processing rather than true floating point processing), and/or are accompanied by high latency (such as many minutes) between when the end user enters their changes and when the end user receives the corresponding modified image.

### BRIEF DESCRIPTION OF THE DRAWINGS

The above needs are at least partially met through provision of the apparatus and method to facilitate user-modified rendering of an object image described in the following detailed description, particularly when studied in conjunction with the drawings, wherein:

FIG. 1 comprises a flow diagram as configured in accordance with various embodiments of the invention;

FIG. 2 comprises an illustrative screen shot as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, one provides a user interface configurable to provide a user (such as an individual) with a plurality of user-manipulable image reconstruction parameters. One also provides a memory having penetrating energy-based image information regarding an object to be rendered stored therein. A viewer (operably coupled to the user interface) is then configurable to render visible an image of this object as a function, at least in part, of this plurality of image reconstruction parameters and a reconstructor (operably coupled to the user interface, the memory, and the viewer) is configurable to respond, substantially in real time, to user manipulation of a given one of the user-manipulable image reconstruction parameters by facilitating automatic near-time rendering of the image of the object as a function, at least in part, of the plurality of image reconstruction parameters including a given one of the user-manipulable image reconstruction parameters. (As used herein, the expression “configurable” will be understood to refer to a purposeful and specifically designed and intended state of configurability and is not intended to include the more general notion of something being forcibly capable of assuming some alternative or secondary purpose or function through a subsequent repurposing of a given enabling platform.)

Depending upon the needs and/or opportunities as tend to characterize a given application setting, these user-manipulable reconstruction parameters can comprise objective-content parameters and/or subjective-content parameters. By one approach, the aforementioned near-term rendering of the object image can occur in an automatic manner (for example, upon user assertion of the parameter in question) or can be optionally delayed until the user specifically instructs such rendering to occur.

By one approach, these teachings are further facilitated through inclusion and use of dedicated image processing hardware such as, but not limited to, a graphics card including, but not limited to, a general graphics card. Those skilled in the art will recognize that other possibilities exist in this regard, including but not limited to clustered personal computers, application specific integrated circuits (ASIC's), as well as field programmable gate arrays. Depending upon design requirements and/or needs, such dedicated image processing hardware can be coupled to the aforementioned viewer and/or the reconstructor. Relatively inexpensive choices in this regard can sometimes suffice (depending upon such operational needs as the quantity of data to be reconstructed, desired image quality, and/or the speed at which a solution is required or desired). In many cases, a $1,000-$4,000 solution can adequately serve in place of prior solutions costing $20,000 or more (especially presuming an ability and opportunity to balance image quality against cost and/or speed).

These teachings will further accommodate considerable flexibility with respect to the configuration and arrangement of the aforementioned user interface. By one approach, for example, the user interface can be configurable to provide a plurality of different ways by which at least some of the plurality of user-manipulable image reconstruction parameters can be manipulated by the user. As another optional example, the user interface can be configurable to incline the user towards selecting certain of the user-manipulable image reconstruction parameters before selecting others of the user-selectable image reconstruction parameters. The latter might comprise, for example, prohibiting the user from selecting certain of the user-manipulable image reconstruction parameters before permitting selection of another of the parameters. By one approach, for example, this might comprise guiding the user with a software wizard.

Those skilled in the art will also appreciate that these teachings will accommodate configuring and arranging the reconstructor to reuse previously processed intermediate information that is not affected by a manipulated user-manipulable image reconstruction parameter. These teachings are also readily applied and leveraged in an application setting where only a portion of the image of the object need be reconstructed and rendered.

So configured and arranged, those skilled in the art will recognize and appreciate that these teachings successfully simultaneously achieve two significant design and performance goals that have previously proven elusive; a fast image editing process for use with penetrating energy-based image information that can be readily implemented in a highly cost effective manner. These teachings are readily implemented using known and available technology and platforms. These teachings are also readily scaled to accommodate very high resolution and/or large sized image information files including both two dimensional and three dimensional image renderings.

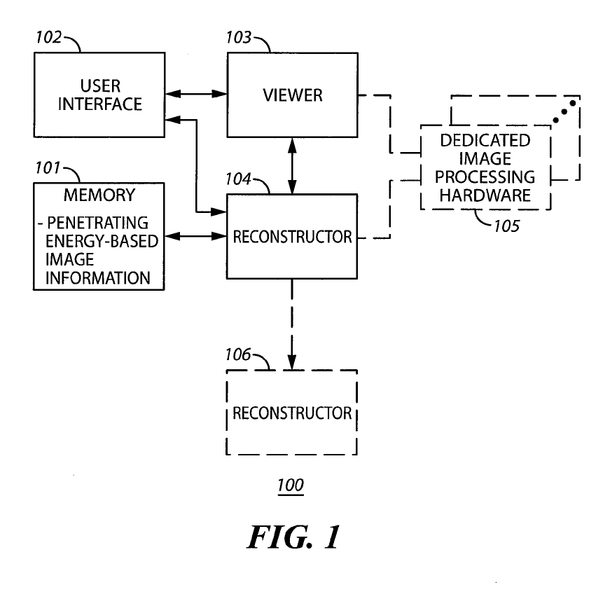

These and other benefits may become clearer upon making a thorough review and study of the following detailed description. Referring now to the drawings, and in particular to FIG. 1, an illustrative image rendering platform 100 as accords with these teachings will be described. Those skilled in the art will recognize and understand that the details of this description are provided for the purposes of illustration and not by way of limitation.

In this illustrative example, the image rendering platform 100 has a memory 101. Those skilled in the art will recognize that this memory 101 can comprise a single integrated component or can be distributed, locally or remotely, over a plurality of discrete components. It will also be recognized that this memory can comprise, in whole or in part, a part of some larger component such as a microprocessor or the like. Such architectural options are well known in the art and require no further elaboration here.

This memory 101 has penetrating energy-based image information regarding an object to be rendered stored therein. The object itself can comprise essentially any object of any size and of any material or materials. It will also be understood that, as used herein, this reference to an object can refer to only a portion of a given discrete item and can also refer to a plurality of discrete objects.

There are various known ways by which such penetrating energy-based image information can be acquired in a first instance. Examples in this regard include, but are not limited to, x-ray-based image information, magnetic resonance imaging-based image information, ultrasonically-based image information, and so forth. As these teachings are not overly sensitive to any particular selection in this regard, for the sake of brevity and the preservation of clarity, further elaboration in this regard will not be presented here. For the sake of example and illustration, however, and not by way of limitation, the remainder of this description will presume that the information comprises high energy-based image information gathered using x-rays using computed-tomography (CT) acquisition techniques and equipment.

This illustrative image rendering platform 100 also comprises a user interface 102. This user interface 102 can comprise both user input and user output elements as desired. For example, this user interface 102 can comprise, in part, an active display of choice (such as a cathode ray tube display or a flat screen technology of choice) by which a rendered image of the object can be presented for visual examination and scrutiny by a user. This user interface 102 can also comprise, as noted, a user input element that might comprise, for example, a touch screen, a key pad, user-graspable/manipulable control surfaces such as knobs, buttons, joysticks, faders, rotating potentiometers, and so forth, and/or a cursor control device, all as are well known in the art.

Pursuant to these teachings, this user interface 102 is configurable to provide a user with a plurality of user-manipulable image reconstruction parameters. This can comprise, by one approach, presenting a screen display that includes, at least in part, these user-manipulable image reconstruction parameters. These user-manipulable image reconstruction parameters can of course vary with the needs and/or opportunities as tend to characterize a given application setting. By one approach, these user-manipulable image reconstruction parameters can comprise one or more objective-content parameters. Objective-content parameters, as denoted by the name itself, refers to parameters that relate to the accuracy of an image's depiction of a given object. Examples in this regard include parameters that relate to scanner geometry, the energy source, and/or the known electronic properties of the detector. With such objective-content parameters a single value typically yields a best image in terms of accuracy.

By one approach, these user-manipulable image reconstruction parameters can include (in combination with the objective-content parameters noted above or in lieu thereof) one or more subjective-content parameters. Subjective-content parameters, again as denoted by the name itself, refers to parameters that relate to more subjective rendering features (such as, for example, parameters that affect noise smoothing, edge enhancement, image resolution, region of interest, reconstruction algorithm choice(s), and various and sundry modifications that may, or may not, provide a correction for one or more artifacts). With such subjective-content parameters, often no single value will be viewed by all potential observers as being the “right” value as these different observers apply differing subjective expectations, needs, and so forth. Furthermore, the “right” value might vary for different types of objects even on the same scanner.

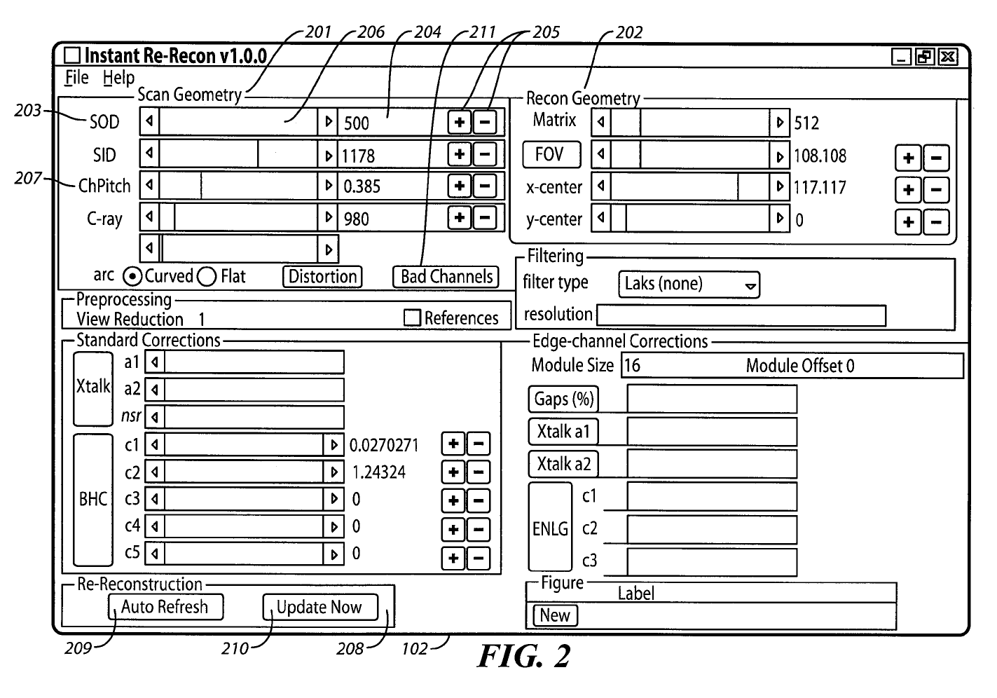

Referring now momentarily to FIG. 2, a screen shot of an illustrative example of a given user interface 102 is shown. Those skilled in the art will recognize and understand that this example is intended to serve only in an illustrative capacity and is not intended to comprise an exhaustive listing of all possibilities in this regard.

In this illustrative example, the user interface 102 provides a plurality of user-manipulable image reconstruction parameters that have a given present setting and that are at least potentially manipulable (and hence adjustable) by the user. Shown, for example, are a grouping of user-manipulable image reconstruction parameters as pertain to scan geometry 201, to reconstruction geometry 202, and others.

Using one such parameter (the SOD parameter 203 as comprises one of the user-manipulable image reconstruction parameters for the scan geometry 201 parameters) as a specific example, the current value of “500” for this parameter appears in a corresponding window 204. If desired, and as illustrated, the user interface 102 can be configurable to provide the user with a plurality of different ways by which as least some of the plurality of user-manipulable image reconstruction parameters can be manipulated by the user.

For example, and again as illustrated, a variety of value-manipulation mechanisms are provided by which the user can change this value. By one approach, the user could select the value in the window 204 (using, for example, a cursor control mechanism of choice such as a mouse, a trackball, or the like) and change the value by directly entering a new desired value (using, for example, a keyboard). As another example, a slider control 206 can also be manipulated as desired (using again, for example, a cursor tool) to increase or decrease (as possible) the displayed parameter value. Increment or decrement buttons, toggle-switches, drop-down boxes, and/or preset-storing functionality can also be incorporated if and as desired. Such value editing tools are generally known in the art and require no further elaboration here aside from noting that in the illustrative example shown, the “Xtalk,” “BHC,” “Gaps,” and “ENLG” buttons comprise toggle buttons that enable/disable the corresponding correction while the “filter type” (for example) comprises a dropdown box.

In this example, the slider control also has zoom buttons 205 associated with it. For example, if the current slider range goes from 500 to 600, and the current value is 500, pressing the zoom-button re-centers the slider range to go from 475 to 525. This allows one to perform both coarse and fine scale adjustments with the same set of entirely graphic controls.

Those skilled in the art will recognize that many parameters are inherently continuous (such as, for example, SID, ChPitch, SOD, and most correction coefficients) whereas some parameters are inherently discrete (such as, for example, matrix size, algorithm selection, filter type, number of views to combine, and so forth). The present teachings are suitable for use with any or all such parameter types.

By one approach, the range of values by which the aforementioned slider controls can be used to adjust the value of the corresponding parameter can comprise the entire adjustable range of the parameter itself. In some cases, however, the parameter values can differ greatly with respect to their absolute values and their corresponding useful adjustment ranges. To illustrate, in the provided example, the SOD parameter 203 has a current value of “500” while the Channel Pitch (ChPitch) parameter 207 has a current value of “0.385.” Accordingly, it will be understood that the adjustment range of the corresponding slider controls can vary amongst the parameters to accommodate such differences. It is also possible for the adjustment range to vary for a given parameter as used with different scanners, and the adjustment range itself may be user adjustable. Those skilled in the art will recognize that the aforementioned zoom control can be quite useful in such settings.

Referring again to FIG. 1, the image rendering platform 100 can also comprise a viewer 103 and a reconstructor 104. The viewer operably couples at least to the user interface 102 and is configurable to render visible an image of the aforementioned object as a function, at least in part, of the plurality of aforementioned reconstruction parameters. Such viewers are generally known in the art and often comprise a software platform that is installed on a hardware platform of choice (such as, but not limited to, a desktop computer).

The reconstructor 104, in turn, is at least operably coupled to the memory 101, the user interface 102, and the viewer 103. The reconstructor 104 is configurable to respond, substantially in real time, to user manipulation of a given one of the user-manipulable image reconstruction parameters by facilitating automatic near-time rendering of the image of the object as a function, at least in part, of the plurality of user-manipulable image reconstruction parameters including the given one of the user-manipulable image reconstruction parameters. (As used herein, “substantially in real time” will be understood to refer to a small range of temporal possibilities, ranging, for example, from immediately to no more than, say, a few seconds (such as 0.5 seconds, one second, two seconds, three seconds, four seconds, 5 seconds, and so forth, though for some application purposes a bit longer may be accepted as being “substantially in real time”). For practical purposes, the latency reflected in this range is essentially to accommodate the required processing time from when the rendering activity (which includes, for these purposes, both traditional “rendering” as well as reconstruction) commences to when such activity is completed.)

In particular, the reconstructor 104 uses the user-manipulable image reconstruction parameters to effect the various processing needed to incorporate the alterations represented by the user-based manipulation of a given one of the user-manipulable image reconstruction parameters and to pass the result on to the viewer 103 (for example this processing could be CT reconstruction, MRI reconstruction, or ultrasound reconstruction, including optional data and/or image corrections) where that result can then be further processed to make it compatibly displayable via the user interface 102. This can comprise, if desired, essentially redoing the entire reconstruction processing using both the modified and the unmodified user-manipulable image reconstruction parameters.

If desired, however, the reconstructor 104 can be configurable to reuse previously processed intermediate information that is not affected by the given one of the user-manipulable image reconstruction parameters while effecting new reconstruction processing that uses at least the one modified user-manipulable image reconstruction parameter. This can be an effective and efficient mechanism to employ, for example, when the reconstruction process employs (for example) twenty primary incremental processing steps to provide the desired viewer-compatible result. In such a case, and when the modification relates to a parameter that is first employed during, for example, the sixteenth sequential step, these teachings will accommodate reusing the result of the fifteenth step and thereby effectively beginning with the sixteenth step. This, of course, can result in a significant savings with respect to necessary computational requirements and the corresponding processing time. For such purposes, the reconstructor could, for example, save the intermediate results after every processing step, or at only a small number of select steps.

By one approach, the reconstructor 104 can be configurable to effect its aforementioned calculations for the entire data set (i.e., for the entire object image). If desired, however, the reconstructor 104 can be configurable to facilitate the aforementioned facilitation of automatic near-time rendering for only an abridgement of the image of the object. This abridgement might comprise, for example, a so-called slice image of the object through some orientation that is either desired by the user or that is computationally convenient. It would also be possible, if desired, for this abridgement to comprise an abridged image of the object (such as a reduced resolution, cropped, or otherwise reduced-content image). As yet another example in this regard, it would be possible for this abridgement to comprise a sub-volume of the object (as may be useful and appropriate when the image comprises a 3-dimensional image). It would also be possible for the abridgement to comprise a low-quality reconstruction, which can sometimes be useful when the quality loss doesn't obscure the effect of the parameter of interest. For example, the user could choose a low-resolution image, a sub-optimal reconstruction algorithm, and/or re-sample the penetrating energy-based information to get a smaller data set. Other possibilities exist as well.

When providing this automatic near-term rendering of only an abridgement of a given object's image, it may be possible to provide the resultant rendering in an even faster period of time (as it will not be necessary to calculate the complete image with each modification). In such a case, it may then be useful to provide the user (via the user interface) with a mechanism to accept a given result. Such acceptance could then trigger a complete-image rendering of the object. It would also be possible, either alone or in combination with the mechanism just described, to automatically trigger such a full-image rendering upon the passage of some required amount of time following a last user manipulation of any of the user-manipulable image reconstruction parameters. It would also be possible to render progressively less abridged versions of the image as time progresses. For example, upon adjusting a control, a user could be presented with a 256×256 image. If the user does not subsequently touch another (or the same) control, the user can then be automatically presented with a 512×512 image a moment later. Similarly, if the user still does not touch a control, a 1024×1024 image could then be automatically provided another moment later still.

The rendering could also include an analysis portion if desired, including quantitative measurements. For example, each time the image is rendered, the viewer could measure contrast, noise, blur, or dimensional accuracy in the reconstructed image and display these measurements to the user. Furthermore, a search functionality could be employed that iteratively adjusts some desired parameter or plurality of parameters in a way that minimizes (or maximizes) some relevant quality metric, such as image blur. This functionality could be done, for example, using the Nelder-Mead simplex algorithm.

As noted above, these activities of the reconstructor 104 can occur in an automatic manner. If desired, however, the reconstructor 104 can be configurable to also have an optional capability of delaying the near-term rendering of the image of the object until the user has specifically instructed that such rendering should now occur. This might permit, for example, a user to manipulate two different parameters before wishing to view the corresponding result.

In such a case, these teachings will accommodate presenting such an option to the user via, for example, the aforementioned user interface 102. To illustrate, and referring again to FIG. 2, such options can be presented in a given section 208 of the user interface display. In this illustrative example, the user can be presented with the option to effect, or to disable, automatic refreshing of the image in response to parameter manipulations via a corresponding toggle button 209. When selecting a non-automatic mode of operation, another button 210 can then be provided to permit the user to indicate that the image is now to be updated.

As noted above, the user interface 102 can provide a plurality of different user-manipulable image reconstruction parameters. By one approach, these manipulation opportunities can all be present and available at all relevant times. So configured, the user can simply select whichever parameter might be of current interest and effect a corresponding manipulation and adjustment.

If desired, however, the user interface 102 can be configurable to incline the user towards selecting certain of the user-manipulable image reconstruction parameters before selecting others of the user-manipulable image reconstruction parameters. Such an approach might be useful, for example, when both objective and subjective-content parameters are ultimately available to be manipulated. In such a case, it may be beneficial to incline such a user to make changes to objective-content parameters prior to making any changes to a subjective-content parameter.

By one approach, for example, this might comprise providing color coding to suggest to the user a particular sequence of candidate manipulations. By another approach, graphic icons and/or alphanumeric indicators might be provided to offer similar guidance to the user. In such a case, the user is actually free to select any of the parameters, but is “inclined” towards one or more particular parameters by the specific, general, and/or inferred meaning/instructions of such indicators.

By another approach, if desired, the user can be “inclined” more strongly by actually prohibiting the use of one or more of the user-manipulable image reconstruction parameters before selecting (and/or accepting) a first one or more of the user-manipulable image reconstruction parameters. By this approach, for example, manipulation of subjective-content parameters might be prohibited until the user has either effected manipulations of objective-content parameters and/or has somehow otherwise indicated acceptance of those objective-content parameters. For example, a software wizard could guide the user through setting all (or at least some of) the parameters.

Parameters that comprise lists of values may also be accessible through specialized editors if desired. Referring to the illustrative example of FIG. 2, the user can click “Bad Channels” 211 to open an editor that allows the user to change a list of bad detector-channel indices. This editor can also be linked to the auto-refresh button 209 and update-now button 210. As another example, specialized editors, which could be text-based and/or graphics-based, could be used to edit a list of detailed parameters where each detector channel has its own value(s).

By one approach, the aforementioned viewer 103 and/or reconstructor 104 can comprise discrete dedicated purpose hardware platforms or partially or fully soft programmable platforms (with all of these architectural choices being well known and understood in the art). It will also be understood that they can share, in whole or in part, a common enabling platform or they can be completely physically discrete from one another.

It would also be possible, if desired, for this image rendering platform 100 to further comprise dedicated image processing hardware 105 of choice. In such a case, the viewer 103, the reconstructor 104, or both the viewer 103 and the reconstructor 104 can be coupled to such dedicated image processing hardware 105 to thereby permit corresponding use of the latter by the former. Also if desired, the viewer 103 can be coupled to, and configurable to use, a first dedicated image processing hardware platform while the reconstructor 104 is coupled to, and configurable to use, a second, different dedicated image processing hardware platform.

Those skilled in the art that various options may exist with respect to the selection of a particular dedicated image processing hardware platform (and that other choices in these regards are likely to become available in the future). As one useful illustrative example in this regard, this dedicated image processing hardware may comprise a graphics card, such as but not limited to a general graphics card.

A graphics card (also sometimes known in the art as a video card, a graphics accelerator card, or a display adapter) comprises a separate, dedicated computer expansion card that serves to generate and to output images to a display. Such a graphics card usually comprises one or more printed wiring boards having a graphics processing unit, optional video memory, a video BIOS chip (or similar component), a random access memory/digital to analog converter (RAMDAC), a motherboard interface, and processed signal outputs (such as, but not limited to, S-video, DVI, and SVGA outputs). The graphics processing unit in such a graphics card is usually a dedicated graphics microprocessor that has been configurable to be optimized to make the floating point or fixed-point calculations that are often important to graphics rendering.

General graphics cards feature less specialized (and thus more general) processing cores than (conventional) graphics cards, and are available today for only a few hundred dollars. Notwithstanding these low prices as well as the “general” purpose nature of these cards, the applicant has determined that such cards are surprisingly effective when applied as described and can, in fact, assume much of the processing requirements for a viewer and/or reconstructor in an image rendering application setting that makes use of penetrating energy-based image information. Some general graphics cards (such as an nVidia Tesla or an accelerator board featuring the Cell Broadband Engine processor) may contain memory and graphics processing units but lack a digital-to-analog converter and processed signal output, relying on a separate auxiliary conventional graphics card to provide the final video output. It should also be noted that multiple general graphics cards can often be used together, either working independently (where the jobs are parallelized at a high level by a host computer) or working in tandem through an explicit hardware link

Those skilled in the art will appreciate that these teachings will also support the use of one or more (possibly physically remote) additional reconstructors 106. Such additional reconstructors 106 can be operably coupled to the aforementioned reconstructor 104 via, for example, an intervening network (or networks) of choice. So coupled, the image rendering platform's 100 reconstructor 104 can be configurable to export user-manipulable image reconstruction parameters to that additional reconstructor(s) 106 (which may be located miles, or even continents away) to thereby permit the latter to effect reconstruction in ordinary course. When used this way, the apparatus is in effect used to interactively calibrate the reconstructor 106 to produce optimal image quality.

Those skilled in the art will recognize and understand that such an apparatus 100 may be comprised of a plurality of physically distinct elements as is suggested by the illustration shown in FIG. 1. It is also possible, however, to view this illustration as comprising a logical view, in which case one or more of these elements can be enabled and realized via a shared platform. It will also be understood that such a shared platform may comprise a wholly or at least partially programmable platform as are known in the art.

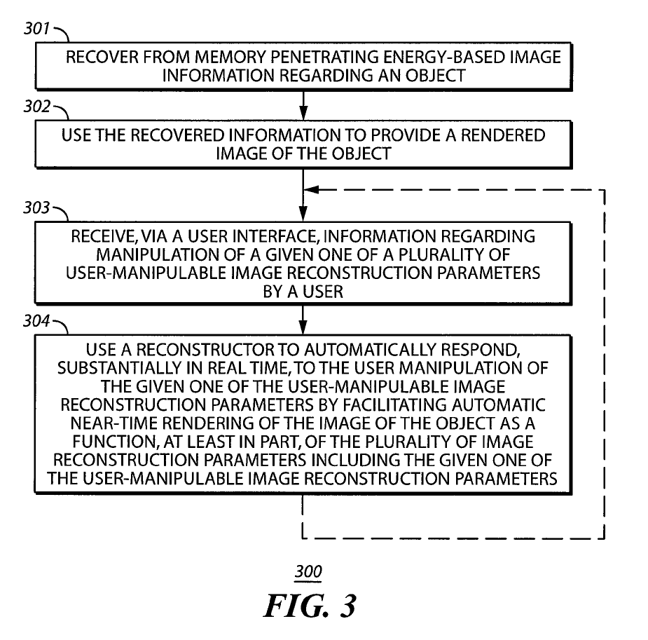

So configured and arranged, and referring now to FIG. 3, such an apparatus 100 can be readily employed to support a process 300 wherein penetrating energy-based image information regarding an object is recovered 301 from memory and used 302 to form a rendered image of that object (using, for example, the aforementioned reconstructor 104, viewer 103, and user interface 102 and by using a present set of user-manipulable image reconstruction parameters (which might comprise, for example, a set of default values, if desired)).

This process 300 will then support, upon receiving 303 (via the aforementioned user interface 102) information regarding manipulation of a given one of a plurality of user-manipulable image reconstruction parameters by a user, using 304 the reconstructor 104 to automatically respond, substantially in real time, to the user manipulation of the given one of the user-manipulable image reconstruction parameters by facilitating automatic near-time rendering of the image of the object as a function, at least in part, of the plurality of image reconstruction parameters including the given one of the user-manipulable image reconstruction parameters.

So configured, those skilled in the art will recognize and appreciate that a user can make any of a variety of image rendering adjustments to a given penetrating energy-based image and receive and perceive the corresponding results of that adjustment within moments. This, in turn, can be used intuitively to determine subsequent adjustments (either to that same parameter or to another parameter of choice). This capability, in turn, can serve to provide such a user with a satisfactory result in a considerably smaller amount of time than typical prior art techniques presently employed and/or with a considerably smaller capital outlay for the enabling equipment. It will be appreciated that these teachings are powerfully suited to leverage existing technologies in a highly cost effective manner. It will also be appreciated that these teachings are readily scaled to accommodate a wide variety of penetrating energy-based image application settings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, these teachings will also support using a server for rendering that consists of a dedicated computer with many graphics cards inside. In such a case, a main card can be used for viewing and another used for rendering. As another example in this regard, these teachings can be leveraged in favor of three-dimensional reconstruction where 3D content must be rendered for a 2D display. This can be viewed as comprising volume rendering (for example, by performing a maximum-intensity projection, surface rendering, ray-tracing, or splatting). This can be done as a 3D to 2D rendering that is done after the 3D reconstruction. By this approach and through use of the disclosed reconstruction techniques, substantially real-time 3D rendering can be accomplished with corresponding real-time reconstruction attached to it.

We claim:

1. An apparatus comprising:
a user interface configurable to provide a user with a plurality of user-manipulable image reconstruction parameters;
a memory having penetrating energy-based image information regarding an object to be rendered stored therein;
a viewer coupled to the user interface and being configurable to render visible an image of the object as a function, at least in part, of the plurality of image reconstruction parameters;
a reconstructor coupled to the user interface, the memory, and the viewer and being configurable to respond, substantially in real time, to user manipulation of a given one of the user-manipulable image reconstruction parameters by facilitating automatic near-time rendering of the image of the object as a function, at least in part, of the plurality of image reconstruction parameters including the given one of the user-manipulable image reconstruction parameters.

2. The apparatus of claim 1 wherein the plurality of user-manipulable image reconstruction parameters comprise, at least in part, objective-content parameters.

3. The apparatus of claim 2 wherein the plurality of user-manipulable image reconstruction parameters comprise, at least in part, subjective-content parameters.

4. The apparatus of claim 1 wherein the reconstructor is further configurable to optionally provide a user with an option of delaying the near-term rendering of the image of the object until the user has specifically instructed such rendering to occur.

5. The apparatus of claim 4 wherein the user interface is further configurable to present the option of delaying the near-term rendering of the image of the object to the user.

6. The apparatus of claim 1 further comprising a graphics card that is coupled to and used by at least one of the viewer and the reconstructor.

7. The apparatus of claim 6 wherein the graphics card comprises a general graphics card.

8. The apparatus of claim 1 further comprising dedicated image processing hardware that is operably coupled to, and used by, the reconstructor.

9. The apparatus of claim 1 further comprising dedicated image processing hardware that is operably coupled to, and used by, the viewer

10. The apparatus of claim 1 wherein the user interface is further configurable to provide a user with a plurality of different ways by which at least some of the plurality of user-manipulable image reconstruction parameters can be manipulated by the user.

11. The apparatus of claim 1 wherein the user interface is further configurable to incline the user towards selecting certain of the user-manipulable image reconstruction parameters before selecting others of the user-manipulable image reconstruction parameters.

12. The apparatus of claim 11 wherein the user interface is further configurable to prohibit the user from selecting the others of the user-manipulable image reconstruction parameters before selecting the certain user-manipulable image reconstruction parameters.

13. The apparatus of claim 1 wherein the reconstructor is further configurable to respond, substantially in real time, to user manipulation of at least one of the user-manipulable image reconstruction parameters by facilitating automatic near-time rendering of the image of the object as a function, at least in part, of:
reusing previously processed intermediate information that is not affected by the given one of the user-manipulable image reconstruction parameters; and
new reconstruction processing that uses the at least one of the user-manipulable image reconstruction parameters.

14. The apparatus of claim 1 wherein the reconstructor is further configurable to respond, substantially in real time, to user manipulation of at least a given one of the user-manipulable image reconstruction parameters by facilitating automatic near-time rendering of only an abridgment of the image of the object as a function, at least in part, of the plurality of image reconstruction parameters including the given one of the user-manipulable image reconstruction parameters.

15. The apparatus of claim 14 wherein the abridgement of the image of the object comprises a slice image.

16. The apparatus of claim 14 wherein the abridgement of the image of the object comprises an abridged image of the object.

17. The apparatus of claim 14 wherein the portion of the image of the object comprises a sub-volume of the object.

18. The apparatus of claim 1 wherein the reconstructor is further configurable to export user manipulated user-manipulable image reconstruction parameters to another reconstructor.

19. A method comprising:
recovering from memory penetrating energy-based image information regarding an object to provide recovered information;
using the recovered information to provide a rendered image of the object;
receiving, via a user interface, information regarding manipulation of a given one of a plurality of user-manipulable image reconstruction parameters by a user;
using a reconstructor to automatically respond, substantially in real time, to the user manipulation of the given one of the user-manipulable image reconstruction parameters by facilitating automatic near-time rendering of the image of the object as a function, at least in part, of the plurality of image reconstruction parameters including the given one of the user-manipulable image reconstruction parameters.
